(19) United States
(12) Patent Application Publication
(10) Pub. No.: US 2009/0295906 A1
(43) Pub. Date: Dec. 3, 2009

(54) Car Side-View Camera

(75) Inventors: Takuya Kushimoto, Tokyo (JP); Yutaka Ishiyama, Tokyo (JP); Takashi Toyoda, Daito-shi (JP); Yoshizumi Nakao, Daito-shi (JP); Yasuo Masaki, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/472,843

(22) Filed: May 27, 2009

(30) Foreign Application Priority Data
May 28, 2008 (JP) 2008-140117

(51) Int. Cl. H04N 7/18; H04N 7/00; H04N 5/33

(52) U.S. Cl. 348/36; 348/148; 348/E07.085; 348/164

(57) ABSTRACT

A car side-view camera has, on the side of a car, a side turn lamp housing containing a compound-eye imaging device and a near-infrared lamp forming the camera. The compound-eye imaging device has 6 imaging units in 2 rows 3 columns. Three imaging units in one row are provided with an infrared cut filter. The imaging units in left and right columns are provided with rectangular prisms to shift light entrance zones left and right. The microprocessor sets the near-infrared lamp in off-state for image capture during the day to combine 3 unit images by the imaging units with the infrared cut filter into a panoramic image, and switches the near-infrared lamp to on-state for image capture at night to combine 3 unit images by the imaging units without the infrared cut filter into a panoramic image. This camera can stably obtain a clear image regardless of day or night.

### BACKGROUND OF THE INVENTION

1. Field of the Invention

The present invention relates to a car side-view camera to be attached to a side of a car body to capture an image of an area around the side of the car body.

2. Description of the Related Art

A car side-view camera is known which is attached to a side of a car body to capture an image of an area around the side of the car body. For example, when parking the car with its side close to an obstacle (such as parking into a garage or close to another car), a driver can accurately recognize the distance from the car to the side obstacle behind the wheel and safely move the car by seeing images captured by the car side-view camera. It is required that a car side-view camera can obtain an image as clear as possible of an area (preferably wide angle area) around the side of the car body at any time, day or night, and match the design of the car without much protruding from the car body.

In order to stably obtain a clear image at night, one may consider attaching, to the side of the car body, a lighting device for emitting infrared light to a target object. However, even if the lighting device matches the design of the car, the use of such lighting device has the following problem in obtaining a clear image regardless of day or night (regardless of the brightness). Generally, a car side-view camera is provided with an infrared (e.g. near-infrared) cut filter for the purpose of securing the color reproduction of images captured during the day. However, at night, the infrared cut filter blocks infrared light reflected from the target object which is illuminated by the lighting device, making it impossible to obtain an image (or sufficiently clear image) of the target object. Conversely, if the infrared cut filter is removed for the purpose of obtaining an image at night, the color reproduction of the captured image during the day has to be sacrificed.

On the other hand, a motion detection imaging device is known which can capture images in a wide capture zone and can be used as a rear monitor camera of a car (refer to e.g. Japanese Laid-open Patent Publication 2008-34948). The motion detection imaging device uses prisms or mirrors to collect and guide light entering in a capture zone to the imaging device. Furthermore, an imaging element is known which can be used to monitor a moving object in an image capture area regardless of the brightness of the image capture area (refer to e.g. Japanese Laid-open Patent Publication 2004-186792). The imaging element has a lens array of two-dimensionally arranged lenses in a matrix of rows and columns as well as visible light pass filters and infrared pass filters arranged alternately to the rows of lenses. The brightness of an image captured with the rows of lenses with the visible light pass filters is compared with that of an image captured with the rows of lenses with the infrared pass filters so as to find which of the images has a higher brightness, and to detect the movement of the moving object based on the captured image having the higher brightness. However, neither of the devices of the two patent publications has a lighting device for emitting infrared light to a target object to stably obtain a clear image even at night, so that they are not suitable for a car side-view camera.

### SUMMARY OF THE INVENTION

An object of the present invention is to provide a car side-view camera which can stably obtain a clear image regardless of day or night (light or dark), and can be mounted on a car body without changing the design of the car body.

According to the present invention, this object is achieved by a car side-view camera to be attached to a side of a car body of a car to capture an image of an area around the side of the car body, the car side-view camera comprising: a compound-eye imaging device having integrated multiple imaging units for collecting light in a capture zone around the side of the car body so as to image unit images; an infrared light source provided for the compound-eye imaging device for emitting infrared light to a capture zone around the side of the car body; and a microprocessor for controlling the entire car side-view camera including the compound-eye imaging device and the light source. A part of the multiple imaging units are provided with an infrared cut filter for cutting infrared light in the collected light (such “part of the multiple images units” being hereafter referred to as “imaging units with the infrared cut filter”) without providing the other imaging units with an infrared cut filter (such “the other imaging units” being hereafter referred to as “imaging units without the infrared cut filter”).

This makes it possible to use, for image capture, both imaging units with the infrared cut filter and imaging units without the infrared cut filter, so that a clear image can be stably obtained regardless of day or night.

Preferably, the microprocessor switches the infrared light source between on-state and off-state. This makes it possible to emit infrared light to the area around the side of the car body in an appropriate time zone.

Further preferably, the car side-view camera further comprises a brightness sensor for detecting ambient brightness around the car side-view camera, wherein the microprocessor switches the infrared light source between the on-state and the off-state according to the ambient brightness detected by the brightness sensor. This makes it possible to obtain a clear image, for example, by turning the infrared light source on at night to emit infrared light to the area around the side of the car body.

It can be designed so that the microprocessor outputs an image based on only a part of the unit images imaged by the multiple imaging units.

Preferably, the imaging units with the infrared cut filter capture images in different capture zones from each other, and the imaging units without the infrared cut filter capture images also in different capture zones from each other. This makes it possible to capture images in a wide capture range.

Further preferably, the capture zones of the imaging units with the infrared cut filter are contiguous to each other, and the capture zones of the imaging units without the infrared cut filter are also contiguous to each other, wherein the microprocessor combines the unit images imaged by the imaging units with the infrared cut filter into a panoramic image, and also combines the unit images imaged by the imaging units without the infrared cult filter into a panoramic image. This makes it possible for the car side-view camera to obtain an image which allows a driver to more easily recognize the situation around the side of the car body.

It can be designed so that the compound-eye imaging device and the infrared light source are contained in a housing of a side turn lamp of the car. This makes it possible to mount the car side-view camera (compound-eye imaging device and the infrared light source) on the car body without changing the design of the car body because it is not necessary to provide an additional or special mounting space for mounting the compound-eye imaging device and the infrared light source.

Preferably, the microprocessor allows the compound-eye imaging device to capture images while the side turn lamp is in the off-state, and to pause the image capture when the side turn lamp is in the on-state. This makes it possible to allow the resultant obtained image to be free of problems such as halation due to the light emitted from the side turn lamp, preventing the image from being unclear.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic side view of a car having attached to a side surface thereof a car side-view camera of the present embodiment;

FIG. 2 is a schematic perspective view of a side turn lamp containing the car side-view camera;

FIG. 3 is a schematic bottom cross-sectional view of a compound-eye imaging device (along line A-A′ in FIG. 4) having an image processing unit in block diagram form and a near-infrared LED lamp with other related elements;

FIG. 4 is a schematic front view of the compound-eye imaging device;

FIG. 5 is a schematic front view of a solid-state imaging element in the compound-eye imaging device;

FIG. 6 is a schematic view showing an example of a panoramic image displayed on a display unit; and

FIG. 7 is a timing chart showing a blinking timing of the side turn lamp, a unit image capture timing of the compound-eye imaging device and an on-timing of the near-infrared LED lamp.

### DESCRIPTION OF THE PREFERRED EMBODIMENTS

Embodiments of the present invention, as best mode for carrying out the invention, will be described hereinafter with reference to the drawings. The present invention relates to a car side-view camera. It is to be understood that the embodiments described herein are not intended as limiting, or encompassing the entire scope of, the present invention. Note that like parts are designated by like reference numerals, characters or symbols throughout the drawings.

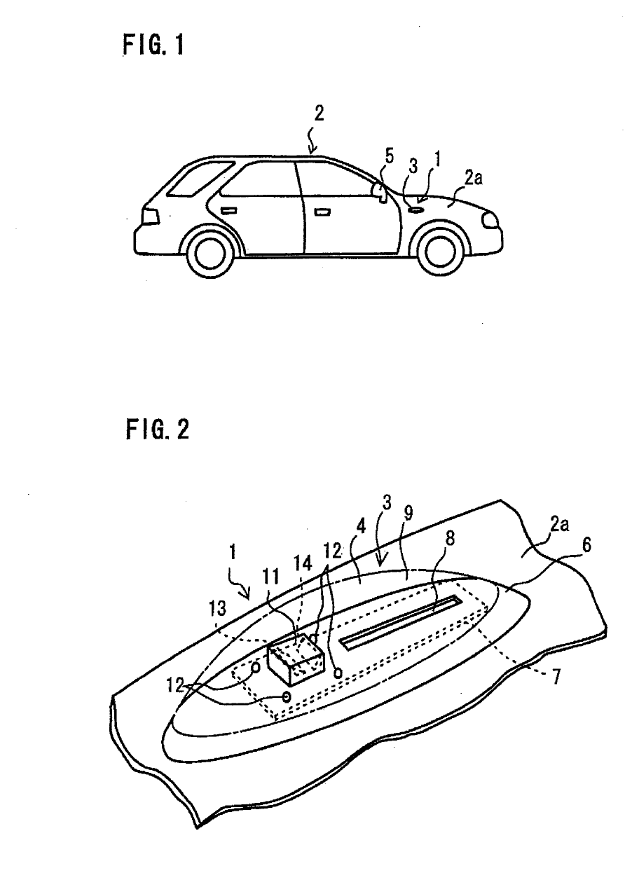

Referring to FIG. 1 to FIG. 7, a car side-view camera 1 according to an embodiment of the present invention will be described. FIG. 1 is a schematic side view of a car 2 having attached to a side surface thereof a car side-view camera 1 of the present embodiment, while FIG. 2 is a schematic perspective view of a side turn lamp 3 containing the car side-view camera 1. As shown in FIGS. 1 and 2, the car side-view camera 1 of the present embodiment is contained in a housing 4 of the side turn lamp 3 attached to each of left and right side surfaces of a car body 2a of the car 2. When a driver operates a turn lever (not shown) to make a left or right turn, the corresponding left or right one of the side turn lamps (more specifically LED lamp 8 described below) is turned on and blinks to notify pedestrians or other cars of the moving direction of the car 2. The side turn lamp 3 can be attached to a portion of the side surface of the car body 2a as shown in FIG. 1 or to a door mirror 5, which is attached to the side of the car body 2a.

As shown in FIG. 2, the side turn lamp 3 comprises: an elliptical-shaped base plate 6 formed integrally with the car body 2a; an LED (light emitting diode) lamp 8 mounted on a circuit board 7 contained in the base plate 6 for emitting a colored light; and a light transparent cover 9 (shown by a dot-dash line as if the cover 9 were removed to show other elements thereunder) to cover an upper surface of the base plate 6. The same one circuit board 7 has mounted thereon a compound-eye imaging device 11 and a near-infrared LED lamp 12 which form the car side-view camera 1. The near-infrared LED lamp 12 can be referred to as an infrared light source for emitting infrared light to a capture zone around the side of the car body 2a for imaging at night or in the dark.

The colored light to be emitted from the LED lamp 8 can be arbitrarily selected, preferably easily visible color such as amber. The compound-eye imaging device 11 has a substantially rectangular parallelepiped shape, and projects from the side surface of the car body 2a more than the light emitting surface of each of the LED lamp 8 and the near-infrared LED lamp 12. The compound-eye imaging device is designed so that the lights emitted from the LED lamp 8 and the near-infrared LED lamp 12 do not interfere with the path of light collected by 45-45-90 degree right-angle prisms 13 and 14 (described later) in a wide capture zone around the side of the car body 2a, preventing problems such as halation in an image captured by the compound-eye imaging device 11.

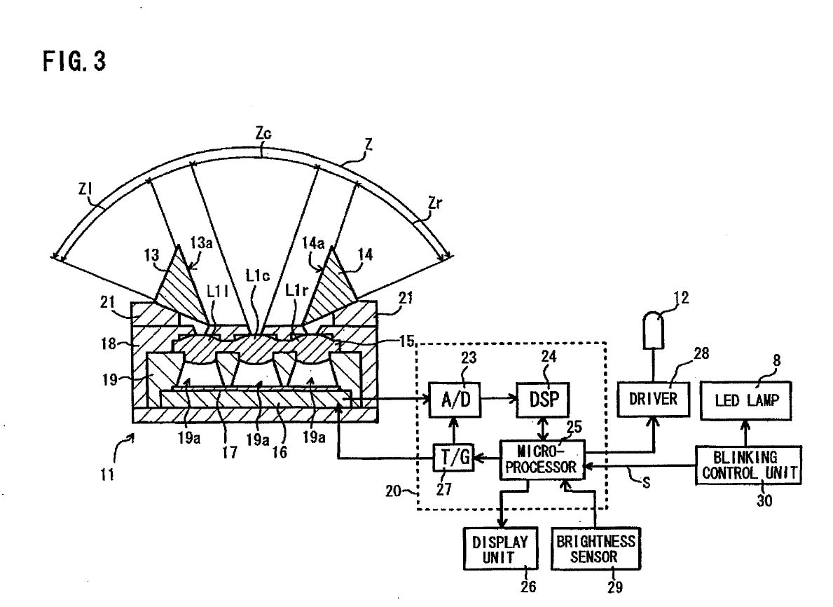

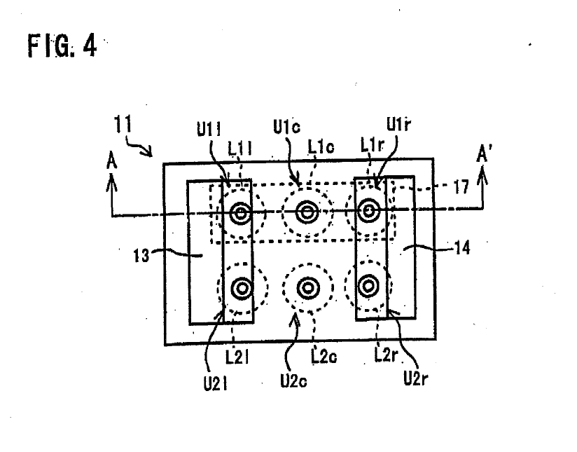

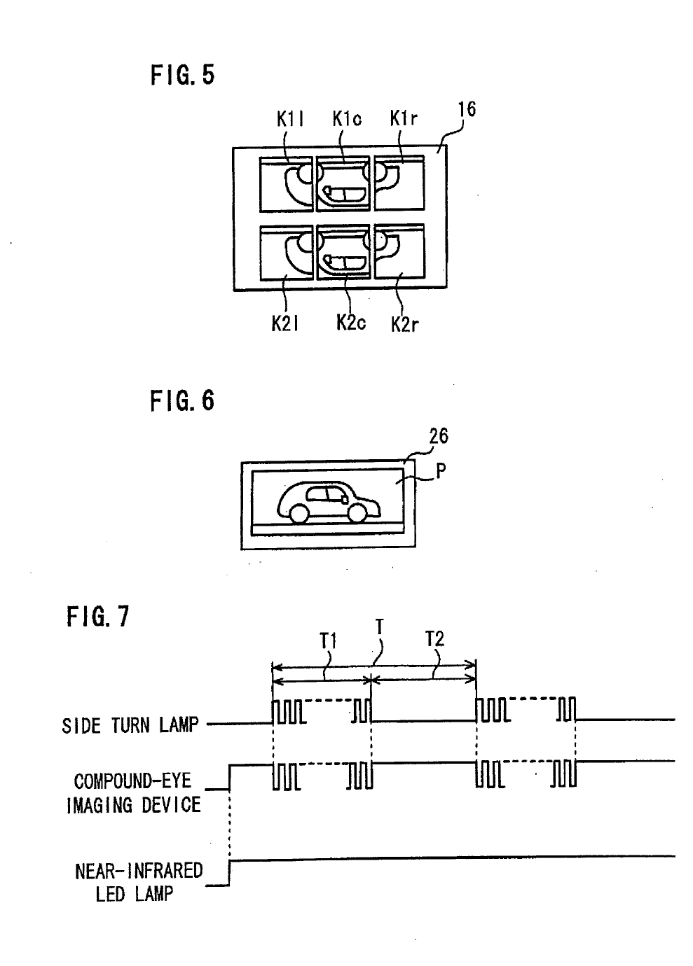

Referring now to FIG. 3 to FIG. 5, the compound-eye imaging device 11 will be described. FIG. 3 is a schematic bottom cross-sectional view of the compound-eye imaging device 11 (along line A-A′ in FIG. 4) having an image processing unit 20 in block diagram form and the near-infrared LED lamp 12 with other related elements, while FIG. 4 is a schematic front view of the compound-eye imaging device 11. On the other hand, FIG. 5 is a schematic front view of a solid-state imaging element (photodetector array) 16 in the compound-eye imaging device 11. As shown in FIG. 3 to FIG. 5, the compound-eye imaging device 11 comprises: an optical lens array 15 having 6 (six) optical lenses L1l, L1c, L1r, L2l, L2c and L2r which have mutually parallel optical axes and are arranged in a matrix of 2 (two) rows and 3 (three) columns on one plane; and a solid-state imaging element (photodetector array) 16 for imaging unit images K1l, K1c, K1r, K2l, K2c and K2r formed by the optical lenses L1l, L1c, L1r, L2l, L2c and L2r, respectively.

The compound-eye imaging device 11 further comprises: two 45-45-90 degree right-angle prisms 13 and 14 placed on the light entrance side of the optical lens array 15 to face the 2 optical lenses L1l and L2l and the 2 optical lenses L1r and L2r in the left and right columns of the matrix, respectively, such that the light entrance zone of light to be collected by the left optical lenses L1l and L2l is shifted (bent) left, and the light entrance zone of light to be collected by the right optical lenses L1r and L2r is shifted (bent) right; an image processing unit 20 for combining the imaged unit images into a panoramic or wide-angle image; and an infrared cut filter (more specifically, near-infrared cut filter) 17 provided on the solid-state imaging element 16 and for the first row of optical lenses L1l, L1c and L1r so as to cut infrared light in the lights which pass through the optical lenses L1l, L1c and L1r and which reach the solid-state imaging element 16 (without providing the second row of optical lenses L2l, L2c and L2r with an infrared cut filter). Note that all of the optical lenses L1l, L1c, L1r, L2l, L2c and L2r have a capture angle of approximately 40°.

Here, the 6 optical lenses L1l, L1c, L1r, L2l, L2c and L2r of the optical lens array 15 and corresponding 6 light receiving areas of the solid-state imaging element 16 which face the 6 optical lenses, respectively, form 6 imaging units U1l, U1c, U1r, U2l, U2c and U2r, respectively, for individually collecting light entering in the capture zone so as to independently image the unit images K1l, K1c, K1r, K2l, K2c and K2r, respectively. In other words, the compound-eye imaging device 11 of the car side-view camera 1 of the present embodiment comprises 6 imaging units U1l, U1c, U1r, U2l, U2c and U2r integrated or arranged in a matrix of 2 rows and 3 columns for collecting light in a capture zone around the side of the car body 2a so as to independently image unit images. The optical lens array 15 is held by a lens holder 18, while a spacer member 19 is inserted between the lens holder 18 and the solid-state imaging element 16. The spacer member 19 has through-holes 19a formed therein at positions facing the respective optical lenses L1l, L1c, L1r, L2l, L2c and L2r so as to allow lights emitted from the respective optical lenses to reach only the light receiving areas corresponding thereto on the solid-state imaging element 16, preventing such lights from interfering with each other.

The 45-45-90 degree right-angle prisms (left and right prisms) 13 and 14 are fixed to the lens holder 18 by a prism holder 21 so as to be inclined at a predetermined angle to the optical lens array 15. More specifically, the left and right prisms 13 and 14 are arranged such that their respective hypotenuses 13a and 14a are inclined at an angle of approximately 70° to the major planes of the optical lens array 15. Thus, referring to FIG. 3, when light enters a wide capture zone Z of approximately 120°, the optical lenses L1c and L2c in the center column collect light entering in a central zone Zc of approximately 40°, and the optical lenses L1l and L2l in the left column collect light entering in a left zone Zl of approximately 40° and bent by the 45-45-90 degree right-angle prism 13, while the optical lenses L1r and L2r in the right column collect light entering in a right zone Zr of approximately 40° and bent by the 45-45-90 degree right-angle prism 14.

The solid-state imaging element 16 is, for example, a CCD (Charge Coupled Device) image sensor or a CMOS (Complementary Metal Oxide Semiconductor) image sensor, and has a major surface on which the 6 unit images K1l, K1c, K1r, K2l, K2c and K2r corresponding to the respective optical lenses L1l, L1c, L1r, L2l, L2c and L2r are formed (refer to FIG. 5) in which the three unit images in each of the set of the unit images K1l, K1c and K1r and the set of K2l, K2c and K2r are contiguous to each other (i.e. left, center and right capture zones are contiguous to each other) to reproduce the image of the target object accurately (without gap or overlap between the unit images). Here, the unit images K1c and K2c of the central zone Zc formed by the center lenses L1c and L2c are inverted up/down and left/right, while the unit images K1l and K2l in the left zone Zl formed by the left lenses L1l and L2l and the unit images K1r and K2r in the right zone Zr formed by the right lenses L1r and L2r are only up/down inverted because the left/right inversion is eliminated by a mirror effect of each of the left and right prisms 13 and 14.

Referring back to FIG. 3, the image processing unit 20 and related operations will be described. The image processing unit 20 comprises: an A/D (Analog-to-Digital) converter 23 connected to the solid-state imaging element 16 for converting the respective unit images K1l, K1c, K1r, K2l, K2c and K2r formed on the solid-state imaging element 16 to digital signals; a DSP (Digital Signal Processor) 24 serving as an image processor for receiving the digital signals from the A/D converter 23 (more specifically, reading the unit images from the solid-state imaging element 16 via the A/D converter 23 at a predetermined timing) and subjecting the digital signals to pixel interpolation and color conversion so as to convert the digital signals to image data free of defects such as missing pixels; a microprocessor 25 for inverting the image data (unit images) from the image processor 24 up/down and left/right to restore the image data to normal unit images (digital) and for combining the normal unit images into a panoramic or wide-angle image (the microprocessor 25 also having an infrared emission selection function or on/off function described below); a display unit 26 such as a liquid crystal panel for displaying the obtained image; and so on. The timing of reading the unit images from the solid-state imaging element 16 is controlled by a T/G (timing generator) 27. FIG. 6 is a schematic view showing an example of a panoramic image P displayed on the display unit 26.

The microprocessor 25 is connected to the near-infrared LED lamp 12 via a driver 28 for controlling on/off of the near-infrared LED lamp 12 and also to a brightness sensor 29 for detecting ambient brightness around the car side-view camera 1 so as to switch the off-state of the near-infrared LED lamp 12 to the on-state when the ambient brightness detected by the brightness sensor 29 drops below a predetermined value (i.e. switch the near-infrared LED lamp 12 between the on-state and off-state according to the detected ambient brightness). The microprocessor 25 is further connected to a blinking control unit 30 which has a microprocessor (not shown) for sending a timing control signal S to the microprocessor 25 and also controlling the blinking of the LED 8 at the same timing as that of the timing control signal S when a driver operates (switches on) the turn lever of the car. The microprocessor 25 reads image data (unit images) while the LED lamp 8 is in the off-sate, so as to produce a panoramic image P based on the read image data, whereas the microprocessor 25 does not read image data (unit images) while the LED lamp 8 is in the on-state. This control of image capture timing of the microprocessor 25 (hence of the compound-imaging device 11 or the car side-view camera 1) will be described in detail later with reference to FIG. 7.

Next, the operation of the car side-view camera 1 of the present embodiment will be described. First, the image capture operation during the day (or in the light) will be described. When the ambient brightness detected by the brightness sensor 29 is equal to or higher than a predetermined value, the microprocessor 25 determines it as the day and sets the near-infrared LED lamp 12 in the off-state, and further produces a panoramic image P based on 3 unit images K1l, K1c and K1r captured by the imaging units U1l, U1c and U1r, which are provided with the near-infrared cut filter 17, out of the 6 unit images K1l, K1c, K1r, K2l, K2c and K2r read from the solid-state imaging element 16. Since the unit images K1l, K1c and K1r are formed by lights whose components in the near-infrared region have been cut by the near-infrared cut filter 17, these unit images have good color reproduction so that the panoramic image P produced by the microprocessor 25 is a clear reproduced image of the wide angle of approximately 120°.

Next, the image capture operation at night (or in the dark) will be described. When the ambient brightness detected by the brightness sensor 29 drops below the predetermined value, the microprocessor 25 determines it as night, and switches the off-state of the near-infrared LED lamp 12 to the on-state, and further produces a panoramic image P based on 3 unit images K2l, K2c and K2r captured by the imaging units U2l, U2c and U2r, which are not provided with the near-infrared cut filter 17, out of the 6 unit images K1l, K1c, K1r, K2l, K2c and K2r read from the solid-state imaging element 16. The unit images K2l, K2c and K2r are formed by lights which are reflected from a target object illuminated by the infrared (near-infrared) light emitted from the near-infrared LED lamp 12, with the components of the lights in the infrared region not being cut by the near-infrared cut filter 17, so that the unit images K2l, K2c and K2r are clear even at night, making the produced panoramic image P also clear.

As described above, the car side-view camera 1 of the present embodiment can obtain a clear panoramic image P regardless of day or night (light or dark) because the near-infrared LED lamp 12 for illuminating the target object at night is used therein. Further, since the car side-view camera 1 is contained in the housing 4 of the side turn lamp 3, the car side-view camera 1 can be mounted on the car body 2a of the car 2 without changing the design of the car body 2a. Note, however, that since the car side-view camera 1 of the present embodiment is contained in the same housing 4 as of the side turn lamp 3, problems such as halation in the captured image may occur due to the light from the LED lamp 8 if the image capture timing of the car side-view camera 1 synchronizes (overlaps) with the blinking timing of the side turn lamp 3 for turn indication. In order to prevent such problems, the image capture timing is controlled in the car side-view camera 1 of the present embodiment as follows.

Referring to FIG. 7, the image capture timing controlled by the microprocessor 25 will be described. FIG. 7 is a timing chart showing a blinking timing of the side turn lamp 3, a unit image capture timing of the compound-eye imaging device 11 (more specifically solid-state imaging element 16) and an on-timing of the near-infrared LED lamp 12. Note that it is assumed here that the near-infrared LED lamp 12 is continuously in the on-state, and the infrared light (near-infrared) light reflected by a target object is continuously collected by the compound-eye imaging device 11. On the other hand, the LED lamp 8 is controlled by the blinking control unit 30 to blink with a predetermined period T (e.g. 0.5 second) of on-time T1 and off-time T2. Even in the on-time T1, the LED lamp 8 repeats fine blinking with alternating fine on/off periods at a predetermined duty ratio (e.g. from 50% to 100%), while the LED lamp 8 is continuously in the off-state during the off-time. Here, the duty ratio is defined as a ratio of the fine on-periods in the on-time T1 to the on-time T1. The fine blinking of the LED lamp 8 in the on-time T1 appears to human eyes as if the LED lamp 8 is continuously in the on-state.

The microprocessor 25 receives the timing control signal S from the blinking control unit 30 which controls the LED lamp 8 in the manner described above so as to detect the blinking timing of the LED lamp 8. Based on the thus detected blinking timing of the LED lamp 8, the microprocessor 25 controls the image capture timing of the solid-state imaging element 16. More specifically, the microprocessor 25 allows the solid-state imaging element 16 to continuously capture unit images during the off-time T2 of the LED lamp 8, while allowing the solid-state imaging element 16 to capture unit images during each of the fine off-periods in the fine blinking during the on-time T1 of the LED lamp 8 without image capturing during the fine on-periods therein.

As described in the foregoing, the image capture operation of the compound-eye imaging device 11 is performed by the microprocessor 25 while the LED lamp 8 is in the off-state, and is paused (or not performed) by the microprocessor 25 when the LED lamp 8 is in the on-state, so that even if the image capture timing of the car side-view camera 1 synchronizes (overlaps) with the blinking timing of the side turn lamp 3 for turn indication, problems such as halation in the captured image due to the light from the LED lamp 8 do not occur, making it possible to obtain a clear image.

It is to be noted that the present invention is not limited to the above embodiments, and various modifications are possible within the spirit and scope of the present invention. For example, in the embodiment described above, the 45-45-90 degree right-angle prisms 13 and 14 are used to bend the capture zone of the optical lenses L1l, L1r, L2l and L2r in the left and right columns to be more left and more right, respectively, than without such prisms so as to widen the capture zone of the compound-eye imaging device 11. However, the 45-45-90 degree right-angle prisms 13 and 14 can be replaced by other optical elements such as mirrors having a similar light bending function. Further, although the three capture zones of each of the imaging units U1l, U1c and U1r and the imaging units U2l, U2c and U2r are contiguous to each other in the above-described embodiment, the three capture zones can be non-contiguous to each other. In this case, the resultant image displayed on the display unit 26 is not of a panoramic image, but of individual separate unit images K1l, K1c, K1r, K2l, K2c and K2r.

It is also possible to display a part of 6 unit images on the display unit 26. For example, the car side-view camera 11 of the present invention can be designed so that only the center unit image K1c formed via the near-infrared cut filter 17 is enlarged and displayed on the display unit 26 for image capture during the day (i.e. an image based on a part of the unit images imaged by the 6 imaging units is output by the microprocessor 25), while only the center unit image K2c is enlarged and displayed on the display unit 26 for image capture at night (i.e. an image based on a part of the unit images imaged by the 6 imaging units is output by the microprocessor 25).

Furthermore, although the microprocessor 25 compares the detected value from the brightness sensor 29 with the predetermined value to switch between the operation using the imaging units U1l, U1c and U1r for image capture during the day and the operation using the imaging units U2l, U2c and U2r for image capture at night, the switching can be such that the microprocessor 25 controls to perform a first operation for image capture during the day, and that when the microprocessor 25 detects a reduction in the clearness of an image obtained by the first operation so as to be lower than a predetermined clearness, the microprocessor 25 controls to perform a second operation for image capture at night.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2008-140117 filed May 28, 2008, the content of which is hereby incorporated by reference.

What is claimed is:

1. A car side-view camera to be attached to a side of a car body of a car to capture an image of an area around the side of the car body, the car side-view camera comprising:
a compound-eye imaging device having integrated multiple imaging units for collecting light in a capture zone around the side of the car body so as to image unit images;
an infrared light source provided for the compound-eye imaging device for emitting infrared light to a capture zone around the side of the car body; and
a microprocessor for controlling the entire car side-view camera including the compound-eye imaging device and the light source,
wherein a part of the multiple imaging units are provided with an infrared cut filter for cutting infrared light in the collected light (such “part of the multiple images units” being hereafter referred to as “imaging units with the infrared cut filter”) without providing the other imaging units with an infrared cut filter (such “the other imaging units” being hereafter referred to as “imaging units without the infrared cut filter”).

2. The car side-view camera according to claim 1,
wherein the microprocessor switches the infrared light source between on-state and off-state.

3. The car side-view camera according to claim 2,
further comprising a brightness sensor for detecting ambient brightness around the car side-view camera,
wherein the microprocessor switches the infrared light source between the on-state and the off-state according to the ambient brightness detected by the brightness sensor.

4. The car side-view camera according to claim 3,
wherein the microprocessor outputs an image based on only a part of the unit images imaged by the multiple imaging units.

5. The car side-view camera according to claim 4,
wherein the imaging units with the infrared cut filter capture images in different capture zones from each other, and the imaging units without the infrared cut filter capture images also in different capture zones from each other.

6. The car side-view camera according to claim 5,
wherein the capture zones of the imaging units with the infrared cut filter are contiguous to each other, and the capture zones of the imaging units without the infrared cut filter are also contiguous to each other, and
wherein the microprocessor combines the unit images imaged by the imaging units with the infrared cut filter into a panoramic image, and also combines the unit images imaged by the imaging units without the infrared cult filter into a panoramic image.

7. The car side-view camera according to claim 2,
wherein the imaging units with the infrared cut filter capture images in different capture zones from each other, and the imaging units without the infrared cut filter capture images also in different capture zones from each other.

8. The car side-view camera according to claim 1,
wherein the compound-eye imaging device and the infrared light source are contained in a housing of a side turn lamp of the car.

9. The car side-view camera according to claim 8,
wherein the microprocessor allows the compound-eye imaging device to capture images while the side turn lamp is in the off-state, and to pause the image capture when the side turn lamp is in the on-state.

10. The car side-view camera according to claim 1,
wherein the imaging units with the infrared cut filter capture images in different capture zones from each other, and the imaging units without the infrared cut filter capture images also in different capture zones from each other.

11. The car side-view camera according to claim 1,
wherein the microprocessor outputs an image based on only a part of the unit images imaged by the multiple imaging units.
